(19) United States
(12) Patent Application Publication
(10) Pub. No.: US 2024/0213883 A1
(43) Pub. Date: Jun. 27, 2024

(54) DC-DC CONVERTERS BASED ON PIEZOELECTRIC TRANSFORMERS

(71) Applicant: Massachusetts Institute of Technology, Cambridge, MA (US)

(72) Inventors: Jessica Boles, Murfreesboro, TN (US); Elaine Ng, Bayside, NY (US); Jeffrey H. Lang, Sudbury, MA (US); David J. Perreault, Cambridge, MA (US)

(73) Assignee: Massachusetts Institute of Technology, Cambridge, MA (US)

(21) Appl. No.: 18/557,172

(22) PCT Filed: Jul. 7, 2022
(86) PCT No.: PCT/US2022/036325

§ 371 Date: Oct. 25, 2023

Related U.S. Application Data
(60) Provisional application No. 63/219,600, filed on Jul. 8, 2021.

(51) Int. Cl. H02M 3/335; H02M 3/00

(52) U.S. Cl. CPC H02M 3/33576; H02M 3/01; H02M 3/33573

(57) ABSTRACT

According to one aspect of the disclosure, a converter having a first port and a second port, the converter comprises: a piezoelectric transformer (PT) having a first port and a second port; one or more first switches configured to operate in accordance with a first switching sub-sequence to transfer energy from the first port of the converter to the first port of the PT, the first switching sub-sequence having at least six (6) stages; and one or more second switches configured to operate in accordance with a second switching sub-sequence to transfer energy from the second port of the PT to the second port of the converter.

### CROSS-REFERENCE TO RELATED APPLICATIONS

This application claims the benefit under 35 U.S.C. § 119 of U.S. Provisional Patent Application No. 63/219,600 filed on Jul. 8, 2021, which is hereby incorporated by reference herein in its entirety.

### FIELD

This disclosure relates generally to power electronics and, more particularly, to converters based upon piezoelectric transformers.

### BACKGROUND

### I. Introduction

Demand for power electronics having smaller volume, lighter weight, and improved manufacturability motivates exploration of alternative converter energy storage mechanisms. Miniaturization tends to be limited by the sizes and performance capabilities of passive components, particularly magnetic elements including inductors and transformers. The achievable power densities of magnetic components fundamentally decrease with volume, which inhibits miniaturization, and even switched-capacitor converter architectures require auxiliary magnetics for efficient voltage regulation. This creates an opportunity in power conversion for alternative passive component technologies that can offer major advances in achievable power density, or power handling capability per volume, without the presence of magnetics.

One promising alternative passive component technology is piezoelectrics, which can be utilized as single-port piezoelectric resonators (PRs) or multi-port piezoelectric transformers (PTs). Piezoelectrics, which store energy in the mechanical compliance and inertia of a piezoelectric material, have higher performance and power density capabilities at small volumes compared to magnetics. Piezoelectrics likewise offer planar form factors, batch fabrication, and the potential for integration. PTs in particular can provide voltage transformation as well as galvanic isolation.

Although piezoelectrics have been used extensively for energy harvesting, sensing, actuation, and transduction, the widespread use of PTs in power conversion has been primarily limited to fluorescent backlight drivers. These designs, along with variations proposed for dc-dc power conversion, typically include auxiliary magnetic component(s) to help achieve zero voltage switching (ZVS) despite the detriment to potential power density.

Existing magnetic-less PT-based converter designs have limited efficiency capabilities. PTs are understood to be capable of efficiencies >95% with sinusoidal drives, but PT-based dc-dc converter power-stage efficiencies tend to be drastically lower. Existing PT-based converter designs rely on standard resonant converter architectures and operating techniques rather than alternative converter implementations dedicated to maximizing PT efficiency.

### SUMMARY

Disclosed herein are isolated and non-isolated dc-dc converters utilizing PTs as their primary, and in some cases only, energy storage components. Also disclosed are converter topologies and switching sequences that can efficiently utilize PTs for energy storage. Disclosed switching sequences can maintain high-efficiency behaviors (e.g., zero voltage switching (ZVS), all-positive instantaneous power transfer, and minimal charge circulation) across wide voltage gain and load ranges. Also disclosed are techniques for deriving these switching sequences' ZVS regions, estimating PT efficiency, and solving for periodic steady state switching times; these offer insights for comparing and implementing design options.

According to one aspect of the disclosure, a converter having a first port and a second port comprises: a piezoelectric transformer (PT) having a first port and a second port; one or more first switches configured to operate in accordance with a first switching sub-sequence to transfer energy from the first port of the converter to the first port of the PT, the first switching sub-sequence having at least six (6) stages; and one or more second switches configured to operate in accordance with a second switching sub-sequence to transfer energy from the second port of the PT to the second port of the converter. The first port of the converter can correspond to either the input port or an output port, and the second port of the converter can correspond to the opposing port.

In some embodiments, the second switching sub-sequence has at least four (4) stages. In some embodiments, the first switching sub-sequence has six (6) stages and the second switching sub-sequence has four (4) stages. In some embodiments, the first switching sub-sequence has six (6) stages and the second switching sub-sequence has six (6) stages.

In some embodiments, the first switching sub-sequence and second switching sub-sequence comprise a switching sequence of the converter, wherein the switching sequence includes: connected stages in which the first port of the PT and the second port of the PT are both connected to one of the first port of the converter, the second port of the converter, or the other port of the PT; and open stages in which at least one of the first port of the PT port or the second port of the PT is not connected by a closed switch to one of the first port of the converter, the second port of the converter, or the other port of the PT. In some embodiments, at least six (6) stages of the first switching alternate between connected stages and open stages. In some embodiments, the second switching sub-sequence has at least four (4) stages alternating between connected stages and open stages.

In some embodiments, the one or more first switches are arranged in a half bridge (HB) topology and the one or more second switches are arranged in a half bridge (HB) topology. In some embodiments, the one or more first switches are arranged in a full bridge (FB) topology and the one or more second switches are arranged in a half bridge (HB) topology. In some embodiments, the one or more first switches are arranged in a half bridge (HB) topology and the one or more second switches are arranged in a full bridge (FB) topology. In some embodiments, the one or more first switches are arranged in a full bridge (FB) topology and the one or more second switches are arranged in a full bridge (FB) topology.

In some embodiments, the first port and second port of the converter are connected by a common-negative. In some embodiments, the PT has three terminals with one of the terminals shared between the first and second port of the PT.

In some embodiments, the converter can further comprise a switching controller configured to operate the one or more first switches in accordance with the first switching sub-sequence and the one or more second switches in accordance with the second switching sub-sequence.

According to another aspect of the disclosure, a converter having a first port and a second port comprises: a piezoelectric transformer (PT) having a first port and a second port; first switches connected between the first port of the converter and the first port of the PT and arranged in a full bridge (FB) topology; and second switches connected between the second port of the converter and the second port, wherein the first and second port of the converter are not isolated, wherein first switches and the second switches configured to operate in accordance with one or more switching sequences to transfer energy from the first port of the converter to the second port of the converter. The first port of the converter can correspond to either the input port or an output port, and the second port of the converter can correspond to the opposing port.

In some embodiments, the first port of the converter and second port of the converter are connected by a common-negative. In some embodiments, the first switches comprise active switches. In some embodiments, the second switches comprise at least one passive switch.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the following claims.

### BRIEF DESCRIPTION OF THE DRAWINGS

The manner of making and using the disclosed subject matter may be appreciated by reference to the attached disclosure documents which, together with this description, form the disclosure of this provisional patent application. The drawings are not necessarily to scale, or inclusive of all elements of a system, emphasis instead generally being placed upon illustrating the concepts, structures, and techniques sought to be protected herein.

FIG. 1 is a block diagram of a system including a dc-dc converter based on a piezoelectric transformer (PT), according to some embodiments.

FIG. 1A is a block diagram of another system including a PT-based converter, according to some embodiments.

FIG. 2 is a schematic diagram of a system having a PT-based converter wherein the source and load are isolated, according to some embodiments.

FIGS. 3A-3D are schematic diagrams of different topologies that can be used with the system of FIG. 2, according to some embodiments.

FIG. 4 is a schematic diagram of a system having a PT-based converter wherein the source and load are non-isolated, according to some embodiments.

FIGS. 5A-5G are schematic diagrams of different topologies that can be used with the system of FIG. 3, according to some embodiments.

FIGS. 6A and 6B is a graphical diagram showing examples of waveforms for a particular switching sequence disclosed herein.

FIGS. 7A and 7B is a graphical diagram illustrating charge transfer that can occur within an isolated PT-based converter, according to some embodiments.

FIG. 8 is a graphical diagram illustrating ZVS region for three isolated switching sequences, according to some embodiments.

FIG. 9A is a graphical diagram showing converter efficiencies that may be achieved for different isolated switching sequences, according to some embodiments.

FIG. 9B is a graphical diagram showing converter efficiencies that may be achieved for different non-isolated switching sequences, according to some embodiments.

FIG. 10 is a graphical diagram showing converter efficiencies that may be achieved at different power levels for a given switching sequence, according to some embodiments.

FIGS. 11A and 11B are schematic diagrams of synthesized topologies for realizing various non-isolated switching sequences, according to some embodiments.

### DETAILED DESCRIPTION

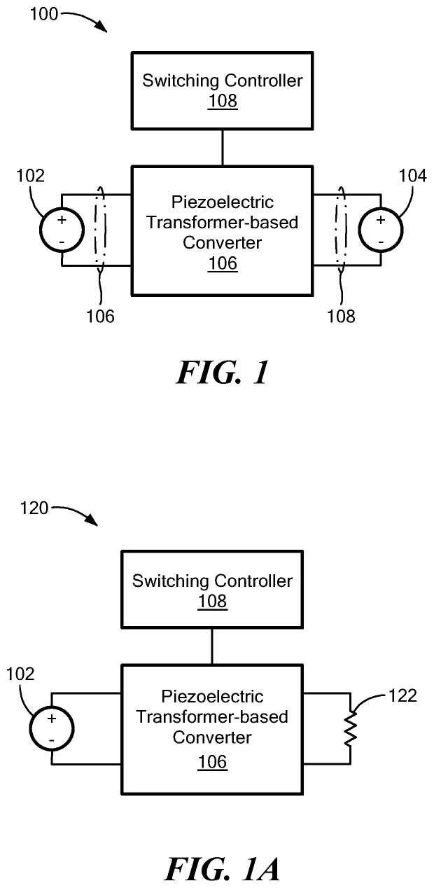

Referring to FIG. 1, an illustrative system 100 can include a source 102, a load 104, a dc-dc converter 106 disposed between the source and load, and a switching controller 108, according to some embodiments. Source 102 can be connected to a first port (or “input”) 106 of the converter 106, and load can be connected to a second port (or “output”) 108 of the converter 106. As shown, the source 102 and load 104 can each correspond to, or be modeled as, a voltage source. Converter 106 may be provided as a step-up or step-down converter. In some embodiments, the source 102 and load 104 may be isolated from each other while, in other embodiments, they may be non-isolated. That is, converter 106 can be provided as either an isolated or a non-isolated converter.

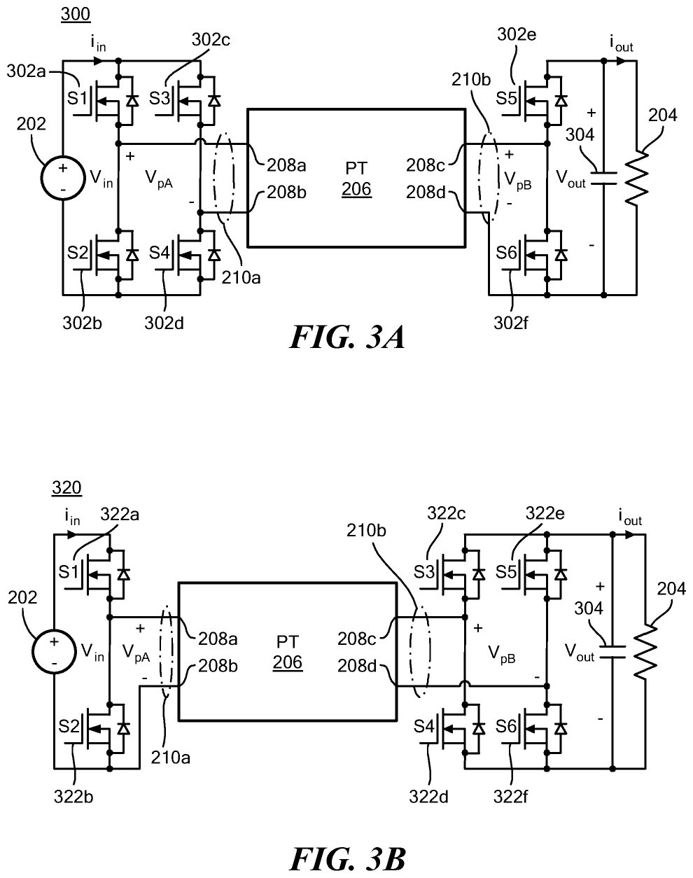

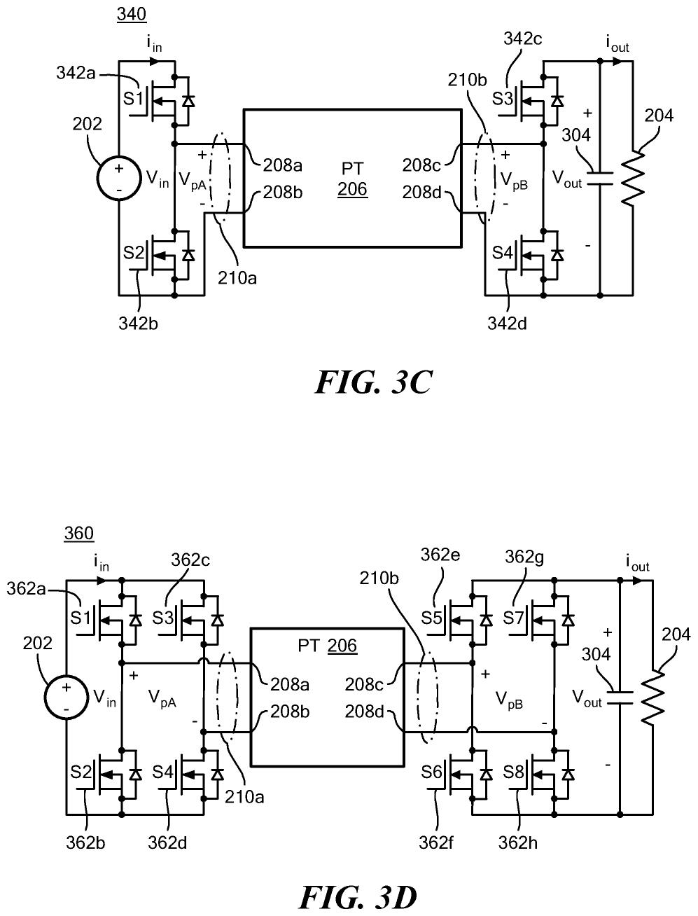

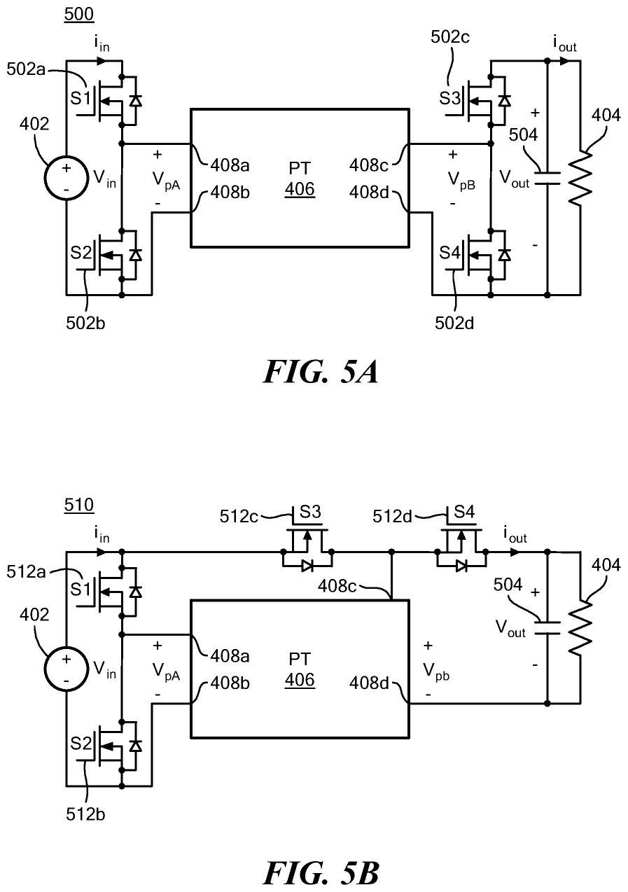

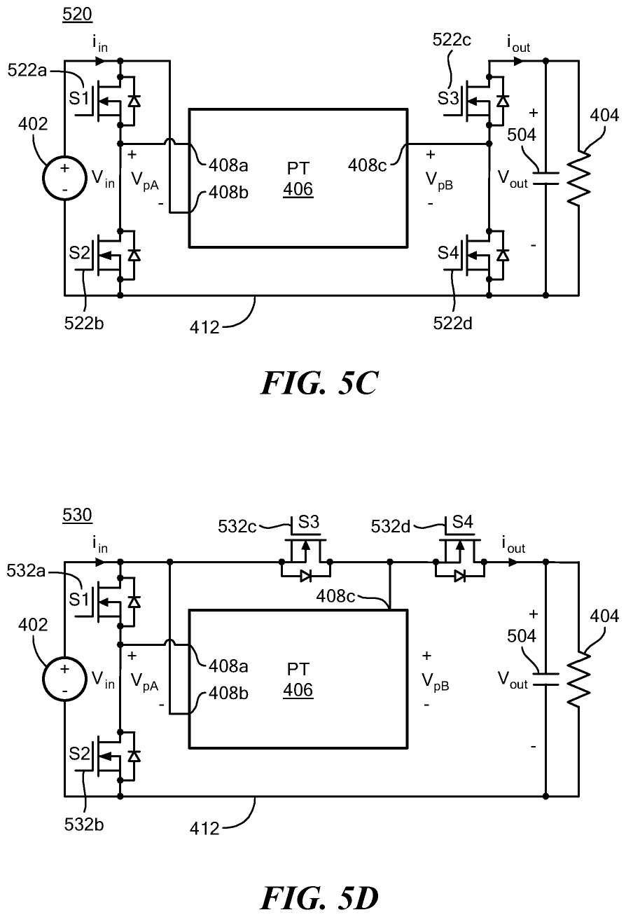

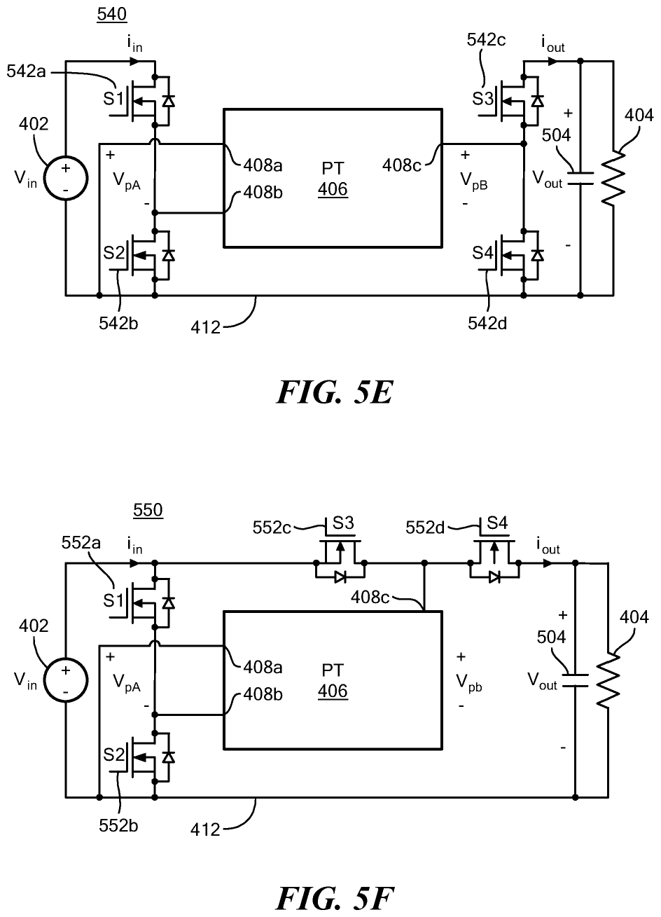

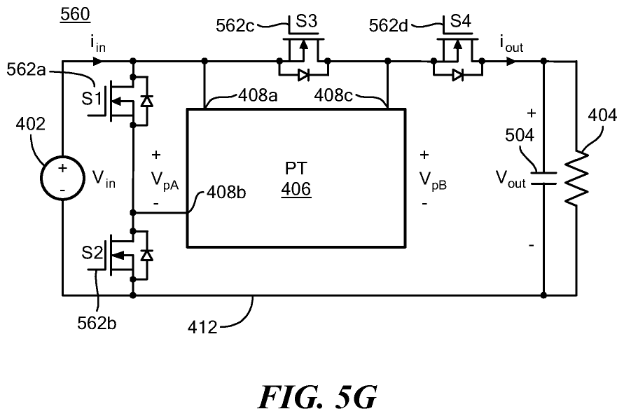

Converter 106 can include one or more piezoelectric transformers (PTs) and one or more switches arranged in given topology to selectively couple the source 102 and load 104 to terminals of the one or more PTs. The switches can include active switches (e.g., field-effect transistors (FETs), metal-oxide-semiconductor field-effect transistors (MOSFETs), etc.) and/or passive switches (e.g., diodes). The one or more PTs may comprise all, or substantially all, of the energy transfer components of converter 106. For example, converter 106 may not include any capacitors, magnetics, or other energy storage components other than the one or more PTs. Thus, converter 106 may be referred to as a “PT-based” converter. Examples of topologies that can be used within converter 106 are shown and described in the context of FIGS. 3A-3D (in the case of an isolated source-load) and of FIGS. 5A-5D (in the case of a non-isolated source-load).

Switching controller 108 can include hardware and/or software configured to control switches within converter 106 according to one or more switching sequences. A switching sequence can be selected to achieve high-efficiency behaviors including ZVS, all-positive instantaneous power transfer, and minimal charge circulation. Techniques for enumerating and selecting such switching sequences are described in detail below. In generally, any of the switching sequences presented herein can be implemented within controller 108, including but not limited to the sequences shown in Tables 2 and 3. In some embodiments, controller 108 can be provided as an application specific integrated circuit (ASIC).

Referring to FIG. 1A, according to another embodiment, a system 120 can include a PT-based converter 106 coupled between a voltage source 102 and a resistive load 122. That is, embodiments of the PT-based converters disclosed herein can be used within systems having voltage source loads, as in FIG. 1, and within systems having resistive loads, as in FIG. 1A.

### II. Isolated Converter Implementations

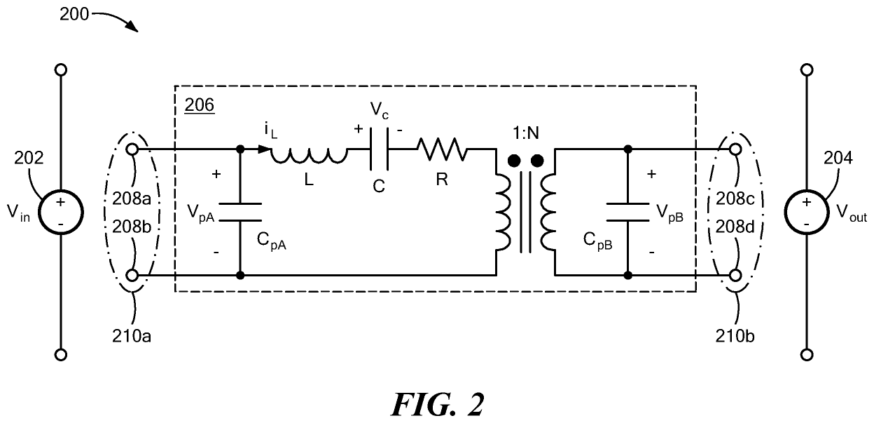

FIG. 2 shows a system 200 having a source 202, a load 204, and a PT 206, according to some embodiments. The source 202 and load 204 are isolated and, thus, may be collectively referred to as an isolated source-load system. The PT 206 has a first port 210a comprising terminals 208a, 208b and a second port 210b comprising terminals 208c, 208d. The source 202 and load 204 can be connected to the ports 210a, 210b via one or more conductive paths and switches (not shown) according to several different implementations (e.g., topologies) enumerated herein. The PT 206, conductive path, and switches may be collectively referred to herein as a PT-based converter.

To enumerate the converter implementations, it can be assumed that the source-load system 202, 204 operates with a constant-voltage load. In FIG. 2, the PT 206 is modeled using a reduced form of the Mason model, which includes physical terminal capacitances, an ideal transformer, and an LCR branch modeling the PT's mechanical resonance properties. The parameters of this model can be assumed to be constant and other terminal capacities may be neglected. The system 200 can be used for both step-up and step-down converter operations. To the extent that particular embodiments are described in terms of step-up operation, the analyses presented herein and be similarly applied to step-down PTs.

### IIA. Stages

To begin enumerating converter implementations, possible stages of a switching cycle can be identified. Each distinct way the terminals 208a, 208b, 208c, 208d (208 generally) of the PT 206 can be connected in the source-load system 200 constitute a possible stage. For the purpose of this disclosure, stages are referred to independently for each port, labeled by the voltage imposed on v_{pA} or v_{pB}. Moreover, the polarity of i_{L} is constrained in each stage for high-efficiency behaviors including ZVS, all-positive instantaneous power transfer, and minimal charge circulation. Thus, stages can be classified as follows:
Connected stages: the PT port is connected to the source-load system 202, 204 such that v_{pA}=±Vᵢₙ or v_{pB}=±Vₒᵤₜ. The polarity of i_{L} is constrained for all-positive instantaneous power transfer.
Zero stages: the PT port is short-circuited, requiring v_{pA} or v_{pB} to equal zero. The polarity of i_{L} may be either positive (denoted Zero+) or negative (denoted Zero-), constrained for unidirectionality to avoid excess charge circulation.
Open stages: the PT port is open-circuited, allowing v_{pA} or v_{pB} to increase or decrease through resonance. The polarity of i_{L} is constrained for charging/discharging C_{pA} or C_{pB} as required for ZVS. One or both terminals may transition in this stage, either simultaneously or sequentially.

Connected stages transfer energy between the PT 206 and the source-load system 202, 204, while zero and open stages redistribute energy within the PT 206. The set of all potential stages is summarized along with i_{L} polarity constraints in Table 1.

TABLE 1
Potential Isolated Stages by Port and i_{L} Polarity

| Polarity | Input Stages (v_{pA} = ) | Output Stages (v_{pB} =) |
|---|---|---|
| i_{L} > 0 | ${V}_{in} ; Zero + ; \frac{{dv}_{pA}}{dt} < 0$ | ${V}_{out} ; Zero + ; \frac{{dv}_{pB}}{dt} > 0$ |
| i_{L} < 0 | $- {V}_{in} ; Zero - ; \frac{{dv}_{pA}}{dt} > 0$ | $- {V}_{out} ; Zero - ; \frac{{dv}_{pB}}{dt} < 0$ |

### II.B. Switching Sequences

These potential stages can be permuted to create switching sequences, defined as order-specific arrangements of stages across a switching cycle. In the case of isolated PTs, sub-sequences can first be identified for each PT port and then combined to create full PT-wide switching sequences. Assuming the stages and i_{L} constraints in Table 1, possible sub-sequences can be enumerated with:
1. A minimum number of stages (for control simplicity).
2. At least one connected stage (for transferring energy to/from the PT).
3. Alternating connected/zero stages and open stages (for ZVS between connected/zero stages).
4. No repetition of the same connected/zero stage.
5. At least one connected/zero stage each for positive and negative i_{L} (for charge balance on C across the cycle).
6. One sequential span each of positive and negative i_{L} (for completion in one PT resonant cycle).

Enumerating all possible sub-sequences and filtering according to these criteria yields two distinct 4-stage sub-sequences and two distinct 6-stage sub-sequences each for the input and output ports of the PT 206. Of note, similar-stage sub-sequences are distinct only if the order of their stages is different, regardless of which stage is listed “first.” Also, the inverted version of a sub-sequence (i.e., all stages having inverted voltage but in the same order) can be considered the same sub-sequence. Multiplied together between the two ports, the enumerated sub-sequences create sixteen (16) full switching sequences that enable ZVS and all-positive instantaneous power transfer in isolated PT-based dc-dc converters. These sequences can be further downselected as discussed in Section II-C.

Throughout this disclosure, a sub-sequence may be referred to by the order of its connected/zero stage voltages (e.g., Vₒᵤₜ, −Vₒᵤₜ, Zero+ for a six-stage sub-sequence), assuming the open stages between each. Full switching sequences may then be denoted by “input-port sub-sequence I output-port sub-sequence” (e.g., Vᵢₙ, −Vᵢₙ|Vₒᵤₜ, −Vₒᵤₜ, Zero+).

### II.C. Practical Considerations

These sixteen (16) potential switching sequences can be filtered based on practical considerations such as wide operating ranges capable of the high-efficiency behaviors listed in Section II-A. First, the periodic steady state operating range of a switching sequence is confined by its ability to balance energy and charge within the PT across a switching cycle. This requires the following energy balance equation to hold, using the Vᵢₙ, −Vᵢₙ|Vₒᵤₜ, −Vₒᵤₜ, Zero+ sequence as an example:

$${V}_{i n} ( \vert {q}_{V i n} \vert + \vert {q}_{- V i n} \vert ) = \frac{{V}_{o u t}}{N} ( \vert {q}_{Vout} \vert + \vert {q}_{- Vout} \vert ) \qquad ( 1 )$$

in which the energy sourced from Vᵢₙ is equated to the energy delivered to the load in a single cycle (assuming an ideal PT), and where qₙ refers to the direction-specific quantity of charge transferred by i_{L} (as shown in FIG. 2) during stage n.

Neglecting open stages for now, charge balance on C requires positive- and negative-i_{L} stages to have equal-magnitude charge transfer. For the same example, this requires:

$$\vert {q}_{V i n} \vert = \vert {q}_{- V i n} \vert = \vert {q}_{Vout} \vert + \vert {q}_{Z e r o +} \vert = \vert {q}_{- Vout} \vert \qquad ( 2 )$$

The solution to equations (1) and (2) is the idealized range of voltage gain supported by this switching sequence. Of note, this voltage conversion range is ideal in that (a) it neglects loss in the PT, and (b) it neglects open stage charge transfer differences between the ports. In this case, |q_{Vout}| can range from 0 to |q_{Vin}| and still satisfy equation (2), allowing equation (1) to become:

$$N < \frac{{V}_{o u t}}{{V}_{i n}} < 2 N \qquad ( 3 )$$

This is the ideal operating range for which this switching sequence provides the desired high-efficiency behaviors. 4×6- and 6×4-stage switching sequences are capable of maintaining such behaviors across wide voltage gain ranges, but 4×4-stage sequences support only specific voltage gains if any. Thus, 4×4-stage sequences are less practical for most power conversion applications and are therefore eliminated from this scope. On the other hand, 6×6-stage sequences exhibit excess charge circulation (resulting in lower efficiencies) and unnecessary control complexity compared to the 4×6- and 6×4-stage sequences, so they can likewise be removed.

The final eight switching sequences are displayed with their ideal voltage gain ranges and other constraints in Table 2. Various embodiments of the present disclosure can make use of these sequences within isolated dc-dc converters.

TABLE 2
Proposed Isolated Switching Sequences, Topologies, and Constraints

| | | | | C_{pA}, C_{pB} |
|---|---|---|---|---|
| | | | | Voltage |
| | | | | Ranges |
| Switching Sequence (Input \| | | Ideal Vₒᵤₜ/Vᵢₙ | Charge Transfer | (VppA, |
| Output) | Topology | Range | Utilization Factors (K) | VppB) |
| Vᵢₙ, −Vᵢₙ\| Vₒᵤₜ, Zero+, Zero− | FB-HB | $2 N < \frac{{V}_{out}}{{V}_{in}} < ∞$ | ${K}_{A} = 1 , 0 < {K}_{B} < \frac{1}{2}$ | 2Vᵢₙ, Vₒᵤₜ |
| Vᵢₙ, −Vᵢₙ\| Vₒᵤₜ, −Vₒᵤₜ, Zero+ | FB-FB | $N < \frac{{V}_{out}}{{V}_{in}} < 2 N$ | ${K}_{A} = 1 , \frac{1}{2} < {K}_{B} < 1$ | 2Vᵢₙ, 2Vₒᵤₜ |
| Vᵢₙ, Zero−\| Vₒᵤₜ, Zero+, Zero− | HB-HB | $N < \frac{{V}_{out}}{{V}_{in}} < ∞$ | ${K}_{A} = \frac{1}{2} , 0 < {K}_{B} < \frac{1}{2}$ | Vᵢₙ, Vₒᵤₜ |
| Vᵢₙ, Zero−\| Vₒᵤₜ, −Vₒᵤₜ, Zero+ | HB-FB | $\frac{N}{2} < \frac{{V}_{out}}{{V}_{in}} < N$ | ${K}_{A} = \frac{1}{2} , \frac{1}{2} < {K}_{B} < 1$ | Vᵢₙ, 2Vₒᵤₜ |
| Vᵢₙ, −Vᵢₙ, Zero−\| Vₒᵤₜ, Zero− | FB-HB | $N < \frac{{V}_{out}}{{V}_{in}} < 2 N$ | $\frac{1}{2} < {K}_{A} < 1 , {K}_{B} = \frac{1}{2}$ | 2Vᵢₙ, Vₒᵤₜ |
| Vᵢₙ, −Vᵢₙ, Zero−\| Vₒᵤₜ, −Vₒᵤₜ | FB-FB | $\frac{N}{2} < \frac{{V}_{out}}{{V}_{in}} < N$ | $\frac{1}{2} < {K}_{A} < 1 , {K}_{B} = 1$ | 2Vᵢₙ, 2Vₒᵤₜ |
| Vᵢₙ, Zero+, Zero−\| Vₒᵤₜ, Zero− | HB-HB | $0 < \frac{{V}_{out}}{{V}_{in}} < N$ | $0 < {K}_{A} < \frac{1}{2} , {K}_{B} = \frac{1}{2}$ | Vᵢₙ, Vₒᵤₜ |
| Vᵢₙ, Zero+, Zero−\| Vₒᵤₜ, −Vₒᵤₜ | HB-FB | $0 < \frac{{V}_{out}}{{V}_{in}} < \frac{N}{2}$ | $0 < {K}_{A} < \frac{1}{2} , {K}_{B} = 1$ | Vᵢₙ, 2Vₒᵤₜ |

### II.D Topologies

Turning to FIGS. 3A-3D, each switching sequence in Table 2 can be realized with either a half-bridge (HB) or a full-bridge (FB) at each PT port, as shown in the four isolated topologies. While the topologies FIGS. 3A-3D are shown as having active switches (e.g., FETs, MOSFETs, etc.), embodiments of the present disclosure can also be implemented using passive switches (e.g., diodes) and/or a combination of active and passive switches. For example, the rectifier switches of these topologies may be implemented passively if the output port uses a 4-stage sub-sequence. Like elements of FIG. 2 are shown using like reference numerals in FIGS. 3A-3D.

FIG. 3A shows a FB-HB topology 300 with four switches 302a-302d (S1-S4) connected between the source 202 and the first port 210a of a PT 206 and two switches 302e, 302f (S5, S6) connected between the load 204 (shown here as a resistive load) and the second port 210b of the PT 206. At the source side, a first PT terminal 208a is connected between switches 302a, 302b. A second PT terminal 208b is connected between switches 302c, 302d. The branch of switches 302a, 302b is connected in parallel with the branch of switches 302c, 302d, and source 202 is connected to all four switches 302a-302d, as shown. At the load side, a third PT terminal 208c is connected between switches 302e, 302f and a fourth PT terminal 208d is connected to a common terminal between switch 302f, output capacitor 304, and load 204. The branch of switches 302e, 302f is connected in parallel with an output capacitor 304 and load 204 is connected to both switches 302e, 302f.

FIG. 3B shows a HB-FB topology 320 with two switches 322a, 322b (S1, S2) connected between the source 202 and the first port 210a of a PT 206 and four switches 322c-322f (S3-S6) connected between the load 204 and the second port 210b of the PT 206. At the source side, the first PT terminal 208a is connected between switches 322a, 322b, the second PT terminal 208b is connected to a common terminal between switch 322b and source 202, and the source 202 is connected to both switches 322a, 322f. At the load side, the third PT terminal 208c is connected between switches 322c, 322d and the fourth PT terminal 208d is connected between switches 322e, 322f. The branch of switches 322c, 322d is connected in parallel with the branch of switches 322e, 322f and with output capacitor 304, and load 204 is connected to all four switches 322c-322f, as shown.

FIG. 3C shows a HB-HB topology 340 with two switches 342a, 342b (S1, S2) connected between the source 202 and the first port 210a of a PT 206 and two switches 342c, 342d (S3, S4) connected between the load 204 and the second port 210b of the PT 206. At the source side, the first PT terminal 208a connected between switches 342a, 342b, the second PT terminal 208b is connected to a common terminal between switch 342b and source 202, and source 202 is connected to both switches 342a, 342b. At the load side, the third PT terminal 208c connected between switches 342c, 342d and the fourth PT terminal 208d is connected to a common terminal between switch 342d and load 204. The branch of switches 342c, 342d is connected in parallel with output capacitor 304, and load is connected to both switches 342c, 342d, as shown.

FIG. 3D shows a FB-FB topology 360 with four switches 362a-362d (S1-S4) connected between the source 202 and the first port 210a of a PT 206 and four switches 362e-362h (S5-S8) connected between the load 204 and the second port 210b of the PT 206. At the source side, first PT terminal 208a is connected between switches 362a, 362b, second PT terminal 208b is connected between switches 362c, 362d, and source 202 is connected to all four switches 362a-362d, as shown. At the load side, the third PT terminal 208c is connected between switches 362e, 326f and the fourth PT terminal 208d is connected between switches 362g, 362h. The branch of switches 362e, 362f is connected in parallel with the branch of switches 362g, 362h and with output capacitor 304, and load 204 is connected to all four switches 362e-322h, as shown.

The sub-sequence enumeration process described herein does not discriminate between the two terminals of a single port (e.g., between terminals 208a, 208b or between terminals 208c, 208d), so topologies containing half-bridges can be similarly implemented with the opposite terminal fixed. Although these resulting topologies are common, it is emphasized that the proposed switching sequences inform operation of these topologies for the desired high-efficiency behaviors. Also, if the rectifier in any of these topologies operates with a 4-stage sub-sequence, it may be implemented passively to simplify control.

### III. Non-Isolated Converter Implementations

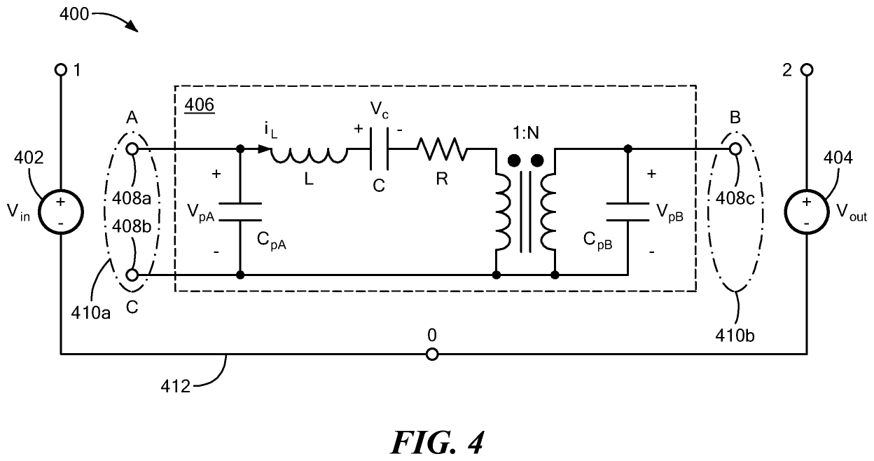

FIG. 4 shows a system 400 having a source 402, a load 404, and a PT 206, according to some embodiments. The source 402 and load 404 are connected by a common-negative 412 and, thus, may be collectively referred to as a non-isolated source-load system or as a common-negative dc-dc source-load system. The PT 406 has a first port 410a comprising terminals 408a, 408b and a second port 410b comprising terminal 408c. Both ports 410a, 410b are be referenced to terminal (or “common node”) 408b, creating a 2-port, 3-terminal device. The source 402 and load 404 can be connected to the ports 410a, 410b via one or more conductive paths and switches (not shown) according to several different implementations (e.g., topologies) enumerated herein. The PT 406, conductive path, and switches may be collectively referred to herein as a PT-based converter.

As in FIG. 2, the PT 406 can be is modeled using a reduced form of the Mason model, which includes physical terminal capacitances, an ideal transformer, and an LCR branch modeling the PT's mechanical resonance properties. The parameters of this model can be assumed to be constant and other terminal capacities may be neglected or also integrated into this model.

Expanding the proposed converter implementations to non-isolated PTs can allow for a wider variety of switching sequences that more efficiently utilize the PT for applications not requiring isolation. The general strategy described in Section II for identifying isolated converter implementations may be adopted for enumerating and downselecting non-isolated converter implementations, though non-isolated PTs do exhibit some key differences. Unlike with isolated PTs, the common node 408b of a non-isolated PT introduces dependence between the two ports 410a, 410b that warrants consideration of both ports together when deriving converter implementations. Also, because the set of potential stages, switching sequences, and topologies is larger without the isolation requirement, additional steps may be taken to downselect these based on practical needs.

Table 3 displays twelve switching sequences that can be used with non-isolated step-up converter implementations, according to embodiments of the present disclosure. Table 3 also shows along with ideal operating ranges and other constraints for these switching sequences. Notably, 6×6 stage sequences are permitted in this set as long as both sub-sequences depend on the same transition of the PT common node 408b for regulation. Also, these implementations may assume C_{pA}>>C_{pB} (typical for a step-up PT), so PT terminals 408a and 408b are prohibited from connecting to the +Vₒᵤₜ node to avoid the impractically-long open stages that would be required to resonate their voltages up to +Vₒᵤₜ for ZVS.

TABLE 3
Proposed Non-isolated Switching Sequences, Topologies, and Constraints

| | | | | Voltage |
|---|---|---|---|---|
| | | | Charge Transfer | Ranges |
| | | | Utilization | (V_{ppA}, |
| Switching Sequence (Input \| Output) | Figure | Ideal Vₒᵤₜ/Vᵢₙ Range | Factors (K) | V_{ppB}) |
| Vᵢₙ, Zero+, Zero−\| Vₒᵤₜ, Zero− | 5A | $0 < \frac{{V}_{out}}{{V}_{in}} < N$ | $0 < {K}_{A} < \frac{1}{2} , {K}_{Bin} = 0 , {K}_{Bout} = \frac{1}{2}$ | Vᵢₙ, Vₒᵤₜ |
| Vᵢₙ, Zero+, Zero−\| Vₒᵤₜ, Vᵢₙ | 5B | $1 < \frac{{V}_{out}}{{V}_{in}} < N + 1$ | $0 < {K}_{A} < \frac{1}{2} , {K}_{Bin} = \frac{1}{2} , {K}_{Bout} = \frac{1}{2}$ | Vᵢₙ, Vₒᵤₜ- Vᵢₙ |
| Zero+, −Vᵢₙ, Zero−\| Vₒᵤₜ−Vᵢₙ, Zero− | 5D | $1 < \frac{{V}_{out}}{{V}_{in}} < N + 1$ | $0 < {K}_{A} < \frac{1}{2} , {K}_{Bin} = \frac{1}{2} , {K}_{Bout} = \frac{1}{2}$ | Vᵢₙ, Vₒᵤₜ- Vᵢₙ |
| Zero+, −Vᵢₙ, Zero−\| Vₒᵤₜ, −Vᵢₙ, Zero− | 5E | $0 < \frac{{V}_{out}}{{V}_{in}} < N - 1$ | $0 < {K}_{A} < \frac{1}{2} , \frac{- 1}{2} < {K}_{Bin} < 0 , {K}_{Bout} = \frac{1}{2}$ | Vᵢₙ, Vₒᵤₜ+Vᵢₙ |
| Zero+, −Vᵢₙ, Zero−\| Vₒᵤₜ, Zero−, Vᵢₙ | 5F | $1 < \frac{{V}_{out}}{{V}_{in}} < N$ | $0 < {K}_{A} < \frac{1}{2} , 0 < {K}_{Bin} < \frac{1}{2} , {K}_{Bout} = \frac{1}{2}$ | Vᵢₙ, Vₒᵤₜ |
| Vᵢₙ, Zero+, Zero−\| Vₒᵤₜ, Vₒᵤₜ−Vᵢₙ, Zero− | 5G | $1 < \frac{{V}_{out}}{{V}_{in}} < N$ | $0 < {K}_{A} < \frac{1}{2} , 0 < {K}_{Bin} < \frac{1}{2} , {K}_{Bout} = \frac{1}{2}$ | Vᵢₙ, Vₒᵤₜ |
| Vᵢₙ, Zero−\| Zero+, Vₒᵤₜ, Zero− | 5A | $N < \frac{{V}_{out}}{{V}_{in}} < ∞$ | ${K}_{A} = \frac{1}{2} , {K}_{Bin} = 0 , 0 < {K}_{Bout} < \frac{1}{2}$ | Vᵢₙ, Vₒᵤₜ |
| Vᵢₙ, Zero−\| Vᵢₙ, Vₒᵤₜ, Vᵢₙ | 5B | $N + 1 < \frac{{V}_{out}}{{V}_{in}} < ∞$ | ${K}_{A} = \frac{1}{2} , 0 < {K}_{Bin} < \frac{1}{2} , 0 < {K}_{Bout} < \frac{1}{2}$ | Vᵢₙ, Vₒᵤₜ- Vᵢₙ |
| Zero+, −Vᵢₙ, \| −Vᵢₙ, Vₒᵤₜ−Vᵢₙ, −Vᵢₙ | 5C | $N < \frac{{V}_{out}}{{V}_{in}} < ∞$ | ${K}_{A} = \frac{1}{2} , {K}_{Bin} = 0 , 0 < {K}_{Bout} < \frac{1}{2}$ | Vᵢₙ, Vₒᵤₜ |
| Zero+, −Vᵢₙ, \| Zero+, Vₒᵤₜ−Vᵢₙ, Zero− | 5D | $N + 1 < \frac{{V}_{out}}{{V}_{in}} < ∞$ | ${K}_{A} = \frac{1}{2} , 0 < {K}_{Bin} < \frac{1}{2} , 0 < {K}_{Bout} < \frac{1}{2}$ | Vᵢₙ, Vₒᵤₜ- Vᵢₙ |
| Zero+, −Vᵢₙ, \| Zero+, Vₒᵤₜ, −Vᵢₙ | 5E | $N - 1 < \frac{{V}_{out}}{{V}_{in}} < ∞$ | ${K}_{A} = \frac{1}{2} , {K}_{Bin} = \frac{- 1}{2} , 0 < {K}_{Bout} < \frac{1}{2}$ | Vᵢₙs Vₒᵤₜ+Vᵢₙ |
| Vᵢₙ, Zero−\| Vᵢₙ, Vₒᵤₜ, Zero− | 5G | $N < \frac{{V}_{out}}{{V}_{in}} < ∞$ | ${K}_{A} = \frac{1}{2} , \frac{- 1}{2} < {K}_{Bin} < 0 , 0 < {K}_{Bout} < \frac{1}{2}$ | Vᵢₙ, Vₒᵤₜ |

FIGS. 5A-5G show several topologies that can be used to realize the non-isolated switching sequences of Table 3. This set of non-isolated topologies is larger than that for isolated PTs, allowing additional opportunities for applications not requiring isolation. While the topologies of FIGS. 5A-5G each have four unidirectional-blocking switches, these topologies could be extended to have full-bridges at their input ports or may be synthesized to provide the capabilities of multiple topologies. Similar to the isolated topologies, the rectifier switches of these topologies may be implemented passively if the output port uses a 4-stage sub-sequence. Table 3 indicates which switching sequences may be used with which topologies by way of references to FIGS. 5A-5G. Like elements of FIG. 4 are shown using like reference numerals in FIGS. 5A-5G.

FIG. 5A shows a non-isolated topology 500 with two switches 502a, 502b (S1, S2) connected between the source 402 and one port of PT 206 and two switches 502c, 502d (S3, S4) connected between the load 404 and the other port of PT 206, as shown. Of note, terminal 408b is common to both PT ports. An output capacitor 504 can be connected in parallel with the load 404.

FIG. 5B shows another non-isolated topology 510 with two switches 512a, 512b (S1, S2) connected between the source 402 and one port of PT 206 and one switch 512d (S4) connected between the load 404 and the other port of PT 206, as shown. Of note, terminal 408b is common to both PT ports. A fourth switch 512c (S3) is connected between the source 402 and load-side switch 512d, in parallel with the PT 406. In some embodiments, switches 512c, 512d (S3, S4) may be implemented as diodes.

FIG. 5C shows another non-isolated topology 520 with two switches 522a, 522b (S1, S2) connected between the source 402 and one port of PT 206 and two switches 522c, 522d (S3, S4) connected between the load 404 and the other port of PT 206, as shown. The source 402 and load 404 are connected by common-negative 412.

FIG. 5D shows another non-isolated topology 530 with two switches 532a, 532b (S1, S2) connected between the source 402 and one port of PT 206 and one switch 532d (S4) connected between the load 404 and the other port of PT 206, as shown. A fourth switch 532c (S3) is connected between the source 402 and load-side switch 532d, in parallel with the PT 406. The source 402 and load 404 are connected by common-negative 412.

FIG. 5E shows another non-isolated topology 540 with two switches 542a, 542b (S1, S2) connected between the source 402 and one port of PT 206 and two switches 542c, 542d (S3, S4) connected between the load 404 and the other port of PT 206, as shown. The source 402 and load 404 are connected by common-negative 412.

FIG. 5F shows another non-isolated topology 550 with two switches 552a, 552b (S1, S2) connected between the source 402 and one port of PT 206 and one switch 552d (S4) connected between the load 404 and the other port of PT 206, as shown. A fourth switch 552c (S3) is connected between the source 402 and load-side switch 552d, in parallel with the PT 406. The source 402 and load 404 are connected by common-negative 412.

FIG. 5g shows another non-isolated topology 560 with two switches 562a, 562b (S1, S2) connected between the source 402 and one port of PT 206 and one switch 562d (S4) connected between the load 404 and the other port of PT 206, as shown. A fourth switch 562c (S3) is connected between the source 402 and load-side switch 562d, in parallel with the PT 406. The source 402 and load 404 are connected by common-negative 412.

### IV. Operating Principle

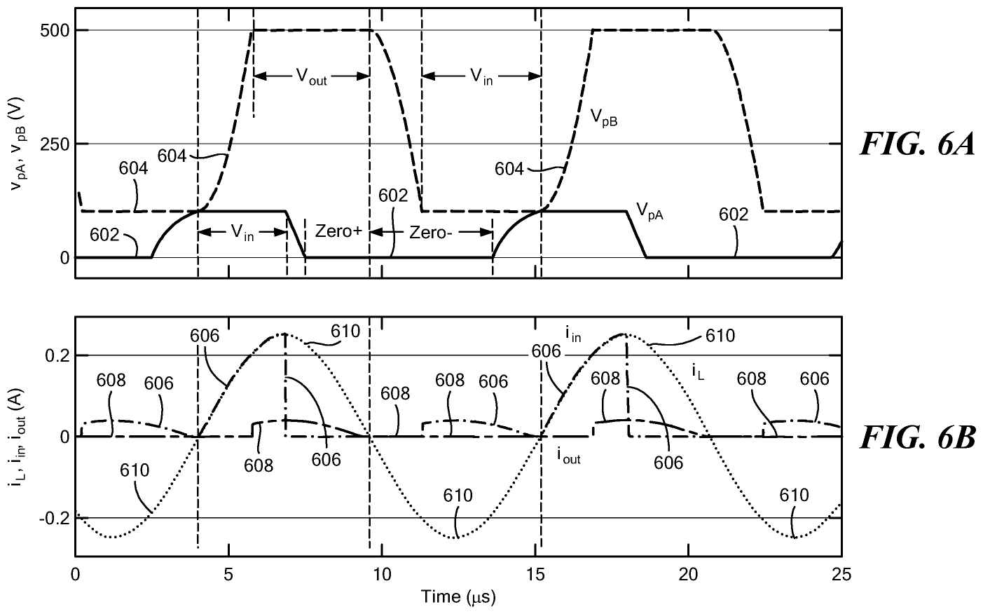

Turning to FIGS. 6A and 6B, with PT-based dc-dc converter implementations established, their general operation is now illustrated with an example. FIGS. 6A and 6B displays waveforms for the non-isolated Vᵢₙ, Zero+, Zero−|Vₒᵤₜ, Vᵢₙ switching sequence; it is recognized herein that this sequence has particularly high efficiency capabilities and can be realized with the topology of FIG. 5B. The following parameters may be assumed in these examples: Vᵢₙ=100 V, Vₒᵤₜ=500 V, and Pₒᵤₜ=5 W, along with the on-board parameters shown in Table 4.

TABLE 4
Example PT Parameter Values

| Parameter | Manufacturer-Provided [37] | | On-board Measurement | |
|---|---|---|---|---|
| C_{pA} | 960 | pF | 1.6 nF (with switches) | |
| C_{pB} | 8 | pF | 83 pF (with diodes) | |
| L | 59 | mH | 44 | mH |
| C | 60 | pF | 72 | pF |
| R | 24 | Ω | 27 | Ω |

| | | |
|---|---|---|
| N | 6 | 6 (assumed) |

In FIG. 6A, a first waveform 602 corresponds to v_{pA} and a second waveform 604 corresponds to v_{pB}, where v_{pA} and v_{pB} refer to the switch nodes between switches S1, S2 and switches S3, S4, respectively, as shown in FIGS. 5A-5G. In FIG. 6B, a first waveform 606 corresponds to iᵢₙ, a second waveform 608 corresponds to iₒᵤₜ, and a third waveform 610 corresponds to i_{L}, as those symbols are used in FIG. 4 and in FIGS. 5A-5G.

The illustrated 6×4-stage sequence has three input-port connected/zero stages and two output-port connected stages as labeled on the waveforms, with open stages between each for ZVS. The waveforms of FIGS. 6A and 6B also illustrate how the sub-sequences of each port align according to i_{L}, providing all-positive instantaneous power transfer as shown by ii, and iₒᵤₜ with unidirectional i_{L} for each stage (minimizing charge circulation). Although other proposed switching sequences are comprised of different stages and sub-sequences, these principles remain the same.

### V. Charge Transfer Analysis

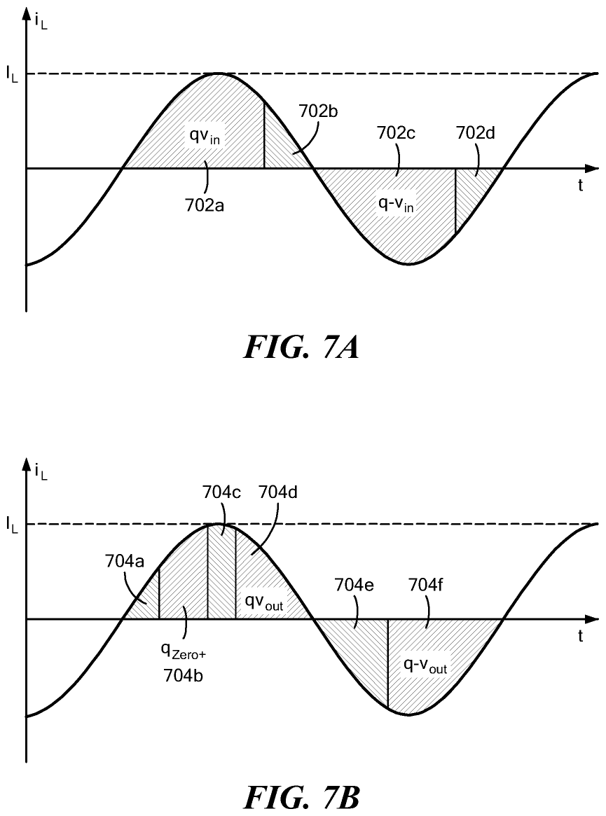

Turning to FIGS. 7A and 7B, PT-based converter switching sequences can be intuitively analyzed using PT charge transfer patterns. FIGS. 7A and 7B illustrate how an assumed-sinusoidal i_{L} cycle can be segmented by input port stages (FIG. 7A) or output port stages (FIG. 7B) for a given switching sequence, namely: Vᵢₙ, −Vᵢₙ|Vₒᵤₜ, −Vₒᵤₜ, Zero+. The regions under the i_{L} curve labeled 702a-702c and 704a-704f (i.e., the sectional integrals of i_{L}) equal the charge transferred during each stage, so charge transfer estimates can lend useful information about the PT's resonant cycle and vice versa. Regions 702b, 702d in FIG. 7A and regions 704a, 704c, 704e in FIG. 7B correspond to open stages whereas the other regions correspond to connected/zero stages. Here PT charge transfer concepts are introduced that serve as foundations for analyses in Sections VI and VII.

### V.A. Charge Transfer Utilization Factor (K)

The switching sequences in Tables 2 and 3 vary widely in how effectively they utilize the PT's resonant cycle to transfer energy. The productivity of a single port's sub-sequence can be quantified with a “charge transfer utilization factor”, K. As defined, K is the proportion of a sub-sequence's connected and zero stage charge transfer that sources energy from the source or delivers energy to the load. K_{A} refers to the input port sub-sequence sourcing energy from Vᵢₙ, and K_{B} refers to the output port sub-sequence delivering energy to Vₒᵤₜ for isolated PTs. For non-isolated PTs, K_{Bin} and K_{Bout} respectively refer to the output port sourcing energy from Vᵢₙ and delivering energy to Vₒᵤₜ.

Using FIGS. 7A and 7B as an example isolated PT sub-sequence,

$${K}_{B} = \frac{{Q}_{c o n n ( V o u t )}}{{Q}_{c o n n} + {Q}_{z e r o}} = \frac{\vert {q}_{{V}_{o u t}} \vert + \vert {q}_{- {V}_{o u t}} \vert}{\vert {q}_{{V}_{o u t}} \vert + \vert {q}_{- {V}_{o u t}} \vert + \vert {q}_{Z e r o +} \vert} \qquad ( 4 )$$

The applicable range for K is bounded by charge balance on capacitance C, which requires the total charge transferred by positive- and negative-i_{L} to be equal. For an individual port, positive and negative open stage charge transfer is balanced for C_{pA} or C_{pB}, so positive and negative connected/zero stage charge transfer must also be balanced for C. For the above example:

$$\vert {q}_{Vout} \vert + \vert {q}_{Z e r o +} \vert = \vert {q}_{- Vout} \vert \qquad ( 5 )$$

Thus, for this example switching sequence, |q_{Vout}| can range from 0 to |q_{-Vout}|, which confines K_{B} to the range

$$\frac{1}{2} < {K}_{B} < 1 .$$

A similar derivation for K_{A} yields K_{A}=1.

When deriving K_{Bin} and K_{Bout} for non-isolated PT sub-sequences, only connected stages involving Vᵢₙ and Vₒᵤₜ, respectively, are considered in the numerator of equation (4). K_{Bin} may be positive or negative depending on whether the output port contributes to or counters energy sourced from Vᵢₙ.

The K values for all switching sequences are displayed in Tables 2 and 3; 4-stage sub-sequences have fixed K values, while 6-stage sub-sequences support ranges of K.

### V.B. Total Charge Transfer

From the perspective of either port, the magnitude of charge transferred by i_{L} during one resonant cycle can be partitioned into connected/zero stage charge transfer (Q_{conn}+Q_{zero}) and open stage charge transfer (Qₒₚₑₙ). A sub-sequence's connected/zero stage charge transfer is the following function of charge sourced/delivered and K, using the input port of the isolated sequence in FIGS. 7A and 7B as an example:

$${Q}_{c o n n} + {Q}_{z e r o} = \frac{{Q}_{i n}}{{K}_{A}} = \frac{{E}_{i n}}{{K}_{A} {V}_{i n}} = \frac{{P}_{i n}}{f {K}_{A} {V}_{i n}} \qquad ( 6 )$$

in which f may be assumed within the PT's inductive region. Of note, the inductive region for a PT is narrow with respect to frequency, so the exact f assumed in this calculation has little effect on the result as long as it falls within the PT's inductive region.

A sub-sequence's open stages collectively charge and discharge C_{pA} or C_{pB} across its full peak-to-peak voltage range V_{ppA} or V_{ppB}, respectively, and these ranges are displayed for each switching sequence in Tables 2 and 3. This results in the following open stage charge transfer for the isolated sequence's input port:

$${Q}_{o p e n} = 2 {C}_{p A} {V}_{p p A} \qquad ( 7 )$$

Thus, the total magnitude of charge that must be transferred by i_{L} during each cycle (Qₜₒₜₐₗ) is:

$${Q}_{total} = {Q}_{c o n n} + {Q}_{z e r o} + {Q}_{open} = \frac{{P}_{i n}}{{fK}_{A} {V}_{i n}} + 2 {C}_{p A} {V}_{p p A} \qquad ( 8 )$$

If one were to instead compute Qₜₒₜₐₗ from the perspective of the output port for this example,

$${Q}_{total} = N ( \frac{{P}_{o u t}}{f {K}_{B} {V}_{o u t}} + 2 {C}_{p B} {V}_{p p B} ) \qquad ( 9 )$$

For non-isolated sequences, K_{B}=K_{Bout} may be substituted into equation (9) for calculating Qₜₒₜₐₗ from the output port's perspective. K_{Bin} impacts the connected/zero stage charge transfer required of the input port's sub-sequence, which must be considered when deriving Qₜₒₜₐₗ from the input port's perspective. For that case,

$${Q}_{total} = \frac{\frac{{P}_{in}}{{fV}_{in}} + 2 {K}_{A} {C}_{pA} {V}_{ppA} + 2 {K}_{Bin} {C}_{pB} {V}_{ppB}}{{K}_{A} + \frac{{K}_{Bin}}{N}} \qquad ( 10 )$$

Qₜₒₜₐₗ provides means to easily assess the PT's total charge transfer, which can be used to derive the PT's amplitude of resonance in Section V-C and ZVS region in Section VI.

### V.C. Amplitude of PT Resonance

The total charge transferred by i_{L} in one resonance cycle can be utilized to estimate the amplitude of i_{L} (I_{L}), which quantifies the PT's amplitude of resonance. If one assumes i_{L} to be sinusoidal as illustrated in FIGS. 7A and 7B, I_{L} can be calculated by equating Qₜₒₜₐₗ to the integral of |i_{L}| over one cycle:

$${Q}_{total} = 2 {\int }_{0}^{\frac{1}{2 f}} {i}_{L} dt = 2 {\int }_{0}^{\frac{1}{2 f}} {I}_{L} sin ( 2 π ft ) dt = \frac{2 {I}_{L}}{π f} ⇒ \qquad ( 11 )$$

$${I}_{L} = \frac{π}{2} f {Q}_{total} = π ( \frac{{P}_{in}}{2 {K}_{A} {V}_{in}} + f {C}_{pA} {V}_{ppA} ) \qquad ( 12 )$$

using the input port of an isolated PT as an example, though I_{L} may also be computed with Qₜₒₜₐₗ of equation (9) or (10). I_{L} may be calculated from the perspective of either PT port, but doing so using a 4-stage-sequence port allows simpler computation with constant K value(s). For six-stage sequences, K varies within a defined range as shown in Section V-A but can be computed based on the operating point as detailed in. This is also required for non-isolated switching sequences for which both K_{Bin} and K_{Bout} are unfixed.

Of note, For PTs with

$$N >> 1 ,$$

$${K}_{Bin} \approx 1 - \frac{{NV}_{in}}{2 {V}_{out}}$$

for the

$${V}_{in} , Zero - \vert {V}_{in} , {V}_{out} , {V}_{in} sequence ,$$

$${K}_{Bin} \approx \frac{{NV}_{in}}{2 {V}_{out}}$$

for the Zero+, −Vᵢₙ, |Zero+, Vₒᵤₜ-Vᵢₙ, Zero− sequence, and

$${K}_{Bin} \approx - \frac{1}{2} + \frac{{NV}_{in}}{2 {V}_{out}}$$

for the Vᵢₙ, Zero−| Vᵢₙ, Vₒᵤₜ, Zero− sequence (based on a known strategy for deriving K).

I_{L} provides important insight into the PT's energy storage and loss, and is employed to analytically estimate efficiency in Section VII.

### VI. Zero-Voltage-Switching Region

Ensuring a switching sequence is capable of ZVS is the first step in evaluating its suitability for a given operating point and PT. In addition to switch capacitances, the PT terminal capacitances C_{pA} and C_{pB} must resonate to exactly their next-stage voltages for ZVS during open stages. Here, the operating region for which a given switching sequence is capable of ZVS is determined considering this open stage charge transfer. This analysis assumes C_{pA} and C_{pB} dominate their respective switch node capacitances, though neighboring switch capacitances may be added to C_{pA} and C_{pB} if significant.

One can examine a given switching sequence's ZVS region by first calculating the total charge transferred by i_{L} (detailed in Section V-B) from the perspective of each port. This calculation considers the charge transfer necessary for all stages of the switching sequence, including open stages for ZVS, assuming the aforementioned constraints (e.g., i_{L} polarities) are preserved. For the isolated case,

$${Q}_{total} = \frac{{P}_{in}}{f {K}_{A} {V}_{in}} + 2 {V}_{ppA} {C}_{pA} = N ( \frac{{P}_{out}}{f {K}_{B} {V}_{out}} + 2 {V}_{ppB} {C}_{pB} ) \qquad ( 13 )$$

and for the non-isolated case,

$$\begin{matrix}{Q}_{total} = \frac{\frac{{P}_{in}}{{fV}_{in}} + 2 {K}_{A} {C}_{pA} {V}_{ppA} + 2 {K}_{Bin} {C}_{pB} {V}_{ppB}}{{K}_{A} + \frac{{K}_{Bin}}{N}} \\ = N ( \frac{{P}_{out}}{f {K}_{Bout} {V}_{out}} + 2 {V}_{ppB} {C}_{pB} )\end{matrix} \qquad ( 14 )$$

The two sides of these Qₜₒₜₐₗ equations are equal by definition and reveal likely-significant differences in the charge transfer requirements for each PT port. For a given operating point, the switching sequence compensates these differences by varying K_{A} and/or K_{B} (K_{A}, K_{Bin}, and/or K_{Bout} for the non-isolated case), which are fixed for 4-stage sequences and confined to specific ranges for 6-stage sequences. Thus, these ranges for K dictate the operating region for which equations (13) and (14) are true, which defines the switching sequence's ZVS region.

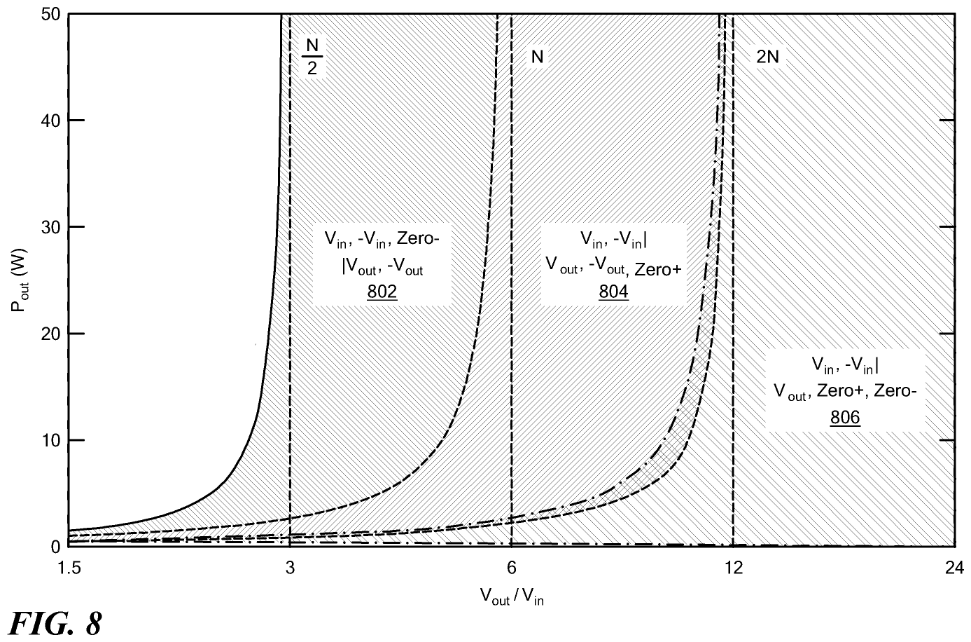

Turning to FIG. 8, equipped with PT parameters and a given switching sequence's V_{ppA}, V_{ppB}, and K boundaries, one can solve equation (13) or (14) for the range of operating points capable of ZVS. Neglecting R in the PT (i.e., Pᵢₙ=Pₒᵤₜ), FIG. 8 maps the ZVS regions of three neighboring isolated switching sequences 802, 804, 806 on power and voltage gain axes, with ideal boundaries are marked with dotted lines, and assuming the manufacturer-provided PT parameters in Table 4 and Vᵢₙ=100 V. This is a useful representation for visualizing the operating regions served by different switching sequences. As shown, sequences 802, 804, 806 allow for a continuous range of ZVS, with boundaries between FB and HB sequences overlapping. As power increases, connected/zero stages dominate the PT's charge transfer, and the boundaries for these ZVS regions approach their ideal Vₒᵤₜ/Vᵢₙ range asymptotes (calculated in Section II-C). Known nonidealities such as loss and parasitic capacitance can be implemented in equation (13) through Pᵢₙ or Pₒᵤₜ and C_{pA} or C_{pB}, respectively, but neither disrupt the continuity of ZVS across sequence combinations.

### VII. Efficiency Estimation

Within topological and ZVS constraints, a switching sequence may be selected for a given PT and operating region based on achievable efficiency. Calculating the PT's exact efficiency for a given switching sequence is not directly accessible without an exact periodic steady state solution, which may require heavy computation. Thus, this section explores tools for analytically estimating PT efficiency.

### VIIA. Efficiency Model

The dominant loss mechanism for a piezoelectric component vibrating in the proximity of its resonant frequency tends to be mechanical loss. Thus, focus is given to the PT's mechanical efficiency for estimating the performance of a PT-based converter implementation. Mechanical efficiency can be estimated using the amplitude of resonance in equation (12) as follows:

$$η = \frac{{P}_{out}}{{P}_{out} + f {E}_{loss}} \approx \frac{{P}_{out}}{{P}_{out} + \frac{1}{2} {I}_{L}^{2} R} \qquad ( 15 )$$

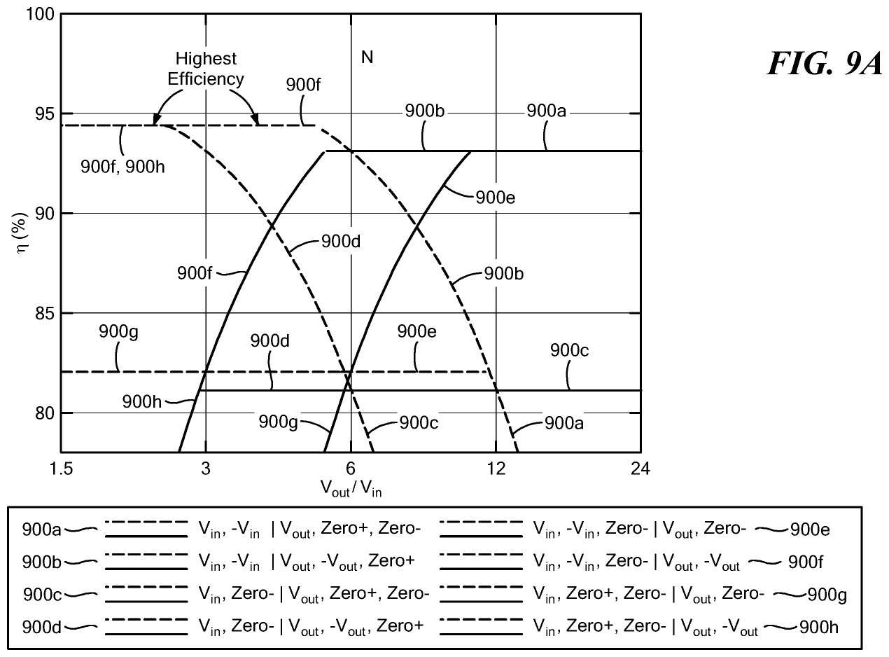

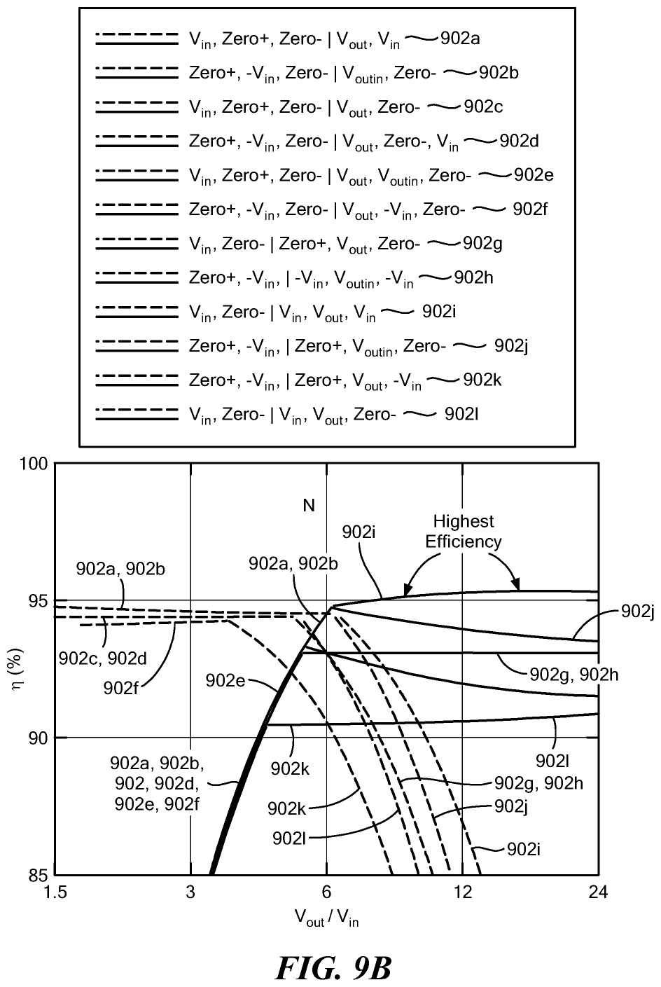

Using this estimation technique, FIGS. 9A and 9B compare the efficiencies of all switching sequences in Tables 2 and 3 across their respective ZVS regions (as derived in Section VI) using the manufacturer-provided PT parameters in Table 4.

FIG. 9A shows estimated efficiency vs.

$$\frac{{V}_{out}}{{V}_{in}}$$

for varying only Vᵢₙ (dashed lines, Vₒᵤₜ=400 V) or only Vₒᵤₜ(solid lines, Vᵢₙ=66.7 V) for isolated sequences 900a-900h with Pₒᵤₜ=8 W. FIG. 9B shows the same, but for non-isolated sequences 902a-902l with Pₒᵤₜ=2 W. The isolated sequences 900a-900h listed in FIG. 9A correspond to the sequences listed in Table 2 whereas the non-isolated sequences 902a-902l listed in FIG. 9B correspond to the sequences listed in Table 3.

Efficiency estimates are based on equation (15), assuming the manufacturer-provided PT parameters in Table 4 and the ZVS regions of equations (13) and (14). Sequences marked by the same style within a plot have indistinguishable efficiency characteristics. In FIGS. 9A and 9B, Vₒᵤₜᵢₙ=Vₒᵤₜ−Vᵢₙ

Beginning at

$$\frac{{V}_{out}}{{V}_{in}} = N ,$$

FIGS. 9A and 9B illustrate how efficiency changes with voltage conversion ratio when varying only Vᵢₙ (dashed lines) or only Vₒᵤₜ (solid lines) for each sequence. The efficiency trends are not symmetrical due to offsets in their ZVS boundaries, but they do demonstrate considerably wide gain ranges with high efficiency.

FIGS. 9A and 9B also reveal significant differences in obtainable efficiency between the sequences themselves. For a given operating point and PT, equation (15) shows that I_{L} should be minimized for high efficiency. However, sequence characteristics that minimize I_{L} are in direct conflict (i.e., a full-bridge sequence enables higher K than a half-bridge sequence but requires twice the open stage charge transfer), creating a tradeoff that must be evaluated by the designer. Full-bridge sequences achieve highest efficiencies for the power level of FIG. 9A, though half-bridge sequences are capable of these efficiencies at a lower power level. Of note, sequence 900c in FIG. 9A is directly comparable with sequences 902g in FIG. 9B and sequence 900g in FIG. 9A is directly comparable with sequences 902c in FIG. 9B, since they can be equally realized with or without isolation. Further, FIG. 9B illustrates how some non-isolated sequences are capable of higher efficiencies than isolation-compatible sequences if permitted by the application. For both plots, the specific implementation that achieves highest efficiency varies based on operating point and PT properties, underscoring the utility of the disclosed estimation technique.

### VII.B. Peak Efficiency

Evaluating the peak achievable efficiency for a given switching sequence and PT is also useful when selecting and designing an implementation. To estimate peak efficiency, q can be directly maximized with respect to operating point parameters. For a switching sequence with a fixed K_{B} or K_{Bout} (i.e., a 4-stage sub-sequence), efficiency is maximized with respect to Pₒᵤₜ when

$${P}_{out} = 2 f {C}_{pB} {V}_{ppB} {V}_{out} {K}_{B} \qquad ( 16 )$$

which provides peak efficiency of

$${η}_{peak} = \frac{1}{1 + \frac{2 {π}^{2} f {N}^{2} {RC}_{pB} {V}_{ppB}}{{K}_{B} {V}_{out}}} \qquad ( 17 )$$

for which K_{B}=K_{Bout} may be substituted for non-isolated sequences. For switching sequences with fixed K_{A}, this maximum efficiency and corresponding power condition can be similarly derived to be functions of C_{pA}, Vᵢₙ, V_{ppA}, and K_{A} (and other relevant parameters related to K_{Bin}, if applicable).

PT-based converters can be designed to achieve maximum efficiency for a nominal operating point by satisfying (16). For example, to increase the maximum-efficiency power level for a given voltage specification, the designer may choose a PT with a higher f*C_{pB} product or a switching sequence with a higher v_{pB}*K_{B} product. Of note, mechanical loss becomes more dominant in the PT at higher power, so the efficiency model is expected to remain valid to the extent that the PT's model parameters remain valid.

It should be noted that the peak efficiency operating point in (17) is only achievable if it falls within the switching sequence's ZVS region.

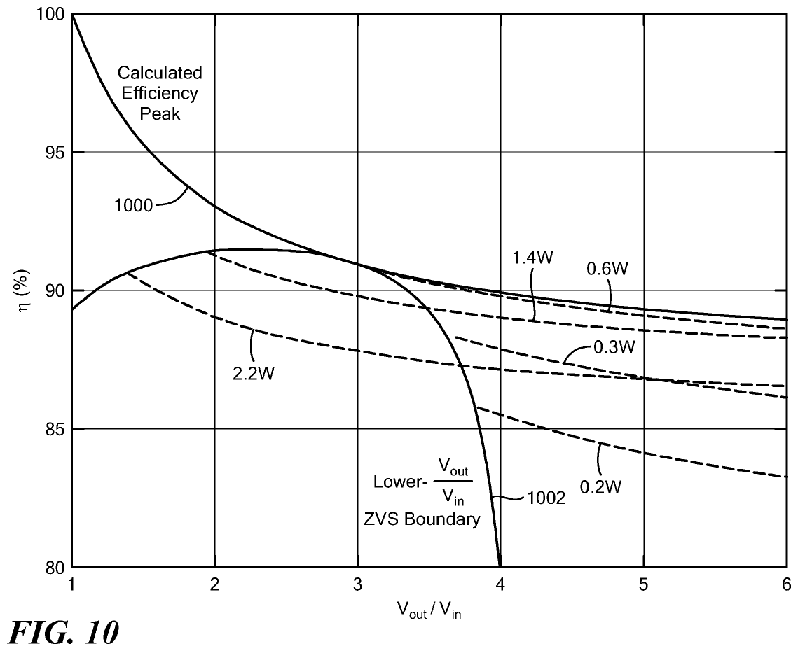

FIG. 10 displays the peak efficiency 1000 and ZVS-boundary efficiency 1002 for the Vᵢₙ, Zero+, Zero−|Vₒᵤₜ, Vᵢₙ switching sequence with the on-board measured PT parameters in Table 4. FIG. 10 shows achievable efficiency vs.

$$\frac{{V}_{out}}{{V}_{in}}$$

for this particular sequence considering the ZVS boundary of equation (14), assuming the on-board PT parameters in Table 4 and Vₒᵤₜ=360 V. In addition to showing curves of peak efficiency 1000 and ZVS-boundary efficiency 1002, FIG. 10 also shows curves for various different power levels (e.g., 0.2 W, 0.3 W, etc.), which are distinguished using different line styles.

As can be seen in FIG. 10,

$$\frac{{V}_{out}}{{V}_{in}} > 3 ,$$

the peak efficiency operating point falls within the ZVS region and can be achieved along with several other high-efficiency operating points surrounding the peak. For

$$\frac{{V}_{out}}{{V}_{in}} < 3 ,$$

the ZVS boundary prevents peak efficiency from being reached, confining the achievable efficiency with ZVS to a lower value.

### VIII. Expanded Non-isolated Topologies

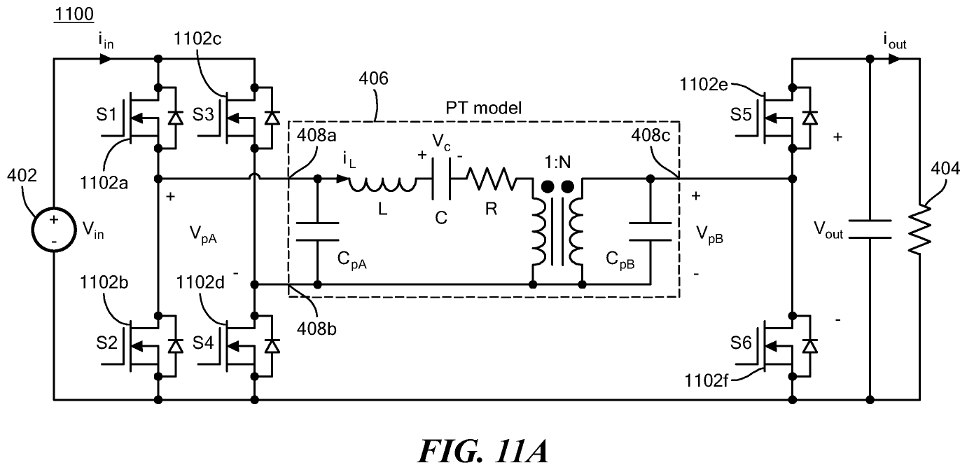

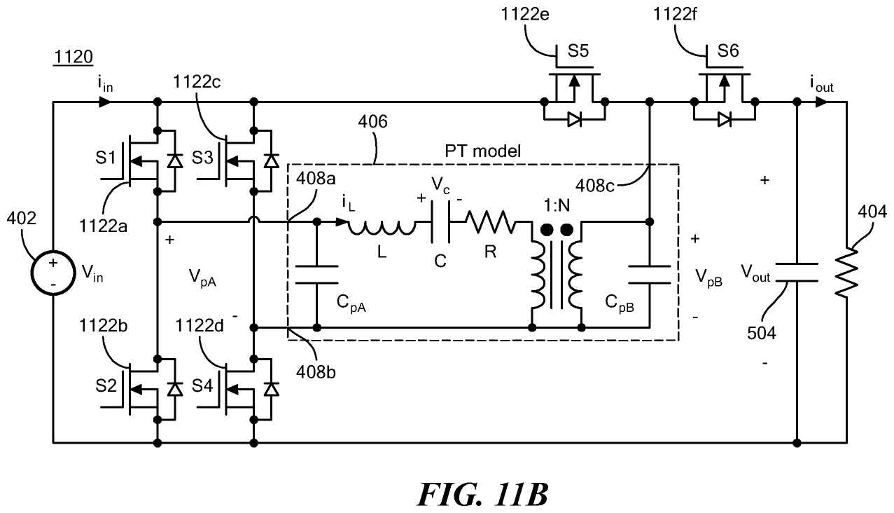

Turning to FIGS. 11A and 111B, the non-isolated switching sequences of Table 3 can be realized with the topologies displayed in FIG. 3, each requiring four unidirectional-blocking switches. To realize multiple sequences, the topologies of FIGS. 5A-5G may be synthesized with additional switches. FIGS. 11A and 11B displays two example topologies that are each capable of realizing multiple switching sequences in Table 3. Further, each of these topologies support their own additional sets of switching sequences that require a full-bridge inverter. Like elements of FIGS. 4 and 5A-5G are shown using like reference numerals in FIGS. 11A and 11B.

FIG. 11A shows another non-isolated topology 1100 with four switches 1102a-1102d (S1-S4) arranged as a full-bridge inverter and connected between the source 402 and one port of the PT 406 (shown using a reduced form of the Mason model). The topology 1100 further includes two switches 1102e, 1102f (S5, S6) connected between the load 404 and the other port of the PT 406.

FIG. 11B shows another expanded non-isolated topology 1120 with four switches 1122a-1122d (S1-S4) arranged as a full-bridge inverter and connected between the source 402 and one port of the PT 406 (shown using a reduced form of the Mason model). The topology 1100 further includes a switch 1122f (S6) connected between the load 404 and the other port of the PT 406, and a switch 1122e (S5) connected between the source 402 and load-side switch 512d, in parallel with the PT 406.

The topologies of FIGS. 5A-5G may be similarly expanded to allow three terminal connections for terminal 408c. In some cases, a bidirectional-blocking switch may be added to accommodate such expansions.

### IX. Conclusion

This disclosure systematically enumerates isolated and non-isolated dc-dc converter implementations that rely solely on a PT for energy storage. This process yields eight isolated switching sequences and twelve non-isolated switching sequences that facilitate high-efficiency behaviors across wide operating ranges. Such high-efficiency behaviors include ZVS, all-positive instantaneous power transfer, and minimum charge circulation. These switching sequences can be realized with various different topologies including topologies shown and described herein, many of which may be implemented with only two active switches.

Charge transfer analysis can be employed to quantify PT cycle utilization, derive ZVS boundaries, and estimate PT efficiency; these steps are useful for selecting the most appropriate converter implementation and/or PT for a given application. ZVS boundaries are continuous across switching sequences but skew at low power due to differences in PT port capacitances. Efficiency estimation through the amplitude of resonance model enables simple comparison of performance between sequences, which vary in relative efficiency capability depending on the desired operating point and boundaries for ZVS. Non-isolated switching sequences are found to be capable of higher efficiencies than isolated sequences for the same PT. Once a converter implementation has been selected, one can solve for periodic steady state switching times that may be used for ideal simulation of a desired converter topology and switching sequence.

This analysis is validated in an experimental prototype based on a commercially-available PT. The proposed switching sequences enable higher whole-converter efficiencies than reported for most magnetic-less PT-based converters through strategic utilization of the PT. The proposed ZVS boundary and efficiency models provide close approximation of the trends observed experimentally, attesting to their utility when selecting an implementation. Assuming further optimization of the PT, PT-based converters are auspicious for high-voltage, low-power applications, especially those requiring significant conversion ratios and/or isolation.

As used herein, the terms “processor” and “controller” are used to describe electronic circuitry that performs a function, an operation, or a sequence of operations. The function, operation, or sequence of operations can be hard coded into the electronic circuit or soft coded by way of instructions held in a memory device. The function, operation, or sequence of operations can be performed using digital values or using analog signals. In some embodiments, the processor or controller can be embodied in an application specific integrated circuit (ASIC), which can be an analog ASIC or a digital ASIC, in a microprocessor with associated program memory and/or in a discrete electronic circuit, which can be analog or digital. A processor or controller can contain internal processors or modules that perform portions of the function, operation, or sequence of operations. Similarly, a module can contain internal processors or internal modules that perform portions of the function, operation, or sequence of operations of the module.

References in the disclosure to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described in connection knowledge of one skilled in the art to affect such feature, structure, or characteristic in connection with other embodiments whether or not explicitly described.

In this disclosure, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

The disclosed subject matter is not limited in its application to the details of construction and to the arrangements of the components set forth in the description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

To the extent that disclosed subject matter is described and illustrated using exemplary embodiments, it is understood that the present disclosure has been made only by way of example, and that numerous changes in the details of implementation of the disclosed subject matter may be made without departing from the spirit and scope of the disclosed subject matter

All publications and references cited herein are expressly incorporated herein by reference in their entirety.

1. A converter having a first port and a second port, the converter comprising:
a piezoelectric transformer (PT) having a first port and a second port;
one or more first switches configured to operate in accordance with a first switching sub-sequence to transfer energy from the first port of the converter to the first port of the PT, the first switching sub-sequence having at least six (6) stages; and
one or more second switches configured to operate in accordance with a second switching sub-sequence to transfer energy from the second port of the PT to the second port of the converter.

2. The converter of claim 1, wherein the first port of the converter is an input port and the second port of the converter is an output port.

3. The converter of claim 1, wherein the first port of the converter is an output port and the second port of the converter is an input port.

4. The converter of claim 1, wherein the second switching sub-sequence has at least four (4) stages.

5. The converter of claim 1, wherein the first switching sub-sequence has six (6) stages and the second switching sub-sequence has four (4) stages.

6. The converter of claim 1, wherein the first switching sub-sequence has six (6) stages and the second switching sub-sequence has six (6) stages.

7. The converter of claim 1, wherein the first switching sub-sequence and second switching sub-sequence comprise a switching sequence of the converter, wherein the switching sequence includes:
connected stages in which the first port of the PT and the second port of the PT are both connected to one of the first port of the converter, the second port of the converter, or the other port of the PT; and
open stages in which at least one of the first port of the PT port or the second port of the PT is not connected by a closed switch to one of the first port of the converter, the second port of the converter, or the other port of the PT.

8. The converter of claim 7, wherein the at least six (6) stages of the first switching alternate between connected stages and open stages.

9. The converter of claim 7, wherein the second switching sub-sequence has at least four (4) stages alternating between connected stages and open stages.

10. The converter of claim 1, wherein the one or more first switches are arranged in a half bridge (HB) topology and the one or more second switches are arranged in a half bridge (HB) topology.

11. The converter of claim 1, wherein the one or more first switches are arranged in a full bridge (FB) topology and the one or more second switches are arranged in a half bridge (HB) topology.

12. The converter of claim 1, wherein the one or more first switches are arranged in a half bridge (HB) topology and the one or more second switches are arranged in a full bridge (FB) topology.

13. The converter of claim 1, wherein the one or more first switches are arranged in a full bridge (FB) topology and the one or more second switches are arranged in a full bridge (FB) topology.

14. The converter of claim 1, wherein the first port and second port of the converter are connected by a common-negative.

15. The converter of claim 1, wherein the PT has three terminals with one of the terminals shared between the first and second port of the PT.

16. The converter of claim 1, further comprising a switching controller configured to operate the one or more first switches in accordance with the first switching sub-sequence and the one or more second switches in accordance with the second switching sub-sequence.

17. A converter having a first port and a second port, the converter comprising:
a piezoelectric transformer (PT) having a first port and a second port;
first switches connected between the first port of the converter and the first port of the PT and arranged in a full bridge (FB) topology; and
second switches connected between the second port of the converter and the second port,
wherein the first and second port of the converter are not isolated,
wherein first switches and the second switches configured to operate in accordance with one or more switching sequences to transfer energy from the first port of the converter to the second port of the converter.

18. The converter of claim 17, wherein the first port of the converter and second port of the converter are connected by a common-negative.

19. The converter of claim 17, wherein the first switches comprise active switches.

20. The converter of claim 17, wherein the second switches comprise at least one passive switch.
